(19) United States
(12) Patent Application Publication
(10) Pub. No.: US 2026/0350365 A1
(43) Pub. Date: Nov. 5, 2026

(54) DERIVING FAITHFUL EXPLANATIONS FOR DEEP MODELS

(71) Applicant: INTERNATIONAL BUSINESS MACHINES CORPORATION, Armonk, NY (US)

(72) Inventors: Franck Vinh Le, West Palm Beach, FL (US); SUPRIYO CHAKRABORTY, White Plains, NY (US)

(21) Appl. No.: 19/057,120

(22) Filed: Feb. 19, 2025

(51) Int. Cl. G06N 3/0475

(52) U.S. Cl. CPC G06N 3/0475

(57) ABSTRACT

A method, system, and computer program product configured to perform operations including: generating a prediction using a trained machine learning model based on an original input including a plurality of input parameters; generating an explanation of which of the plurality of input parameters is most relevant to the prediction based on contextually replacing respective ones of the plurality of input parameters; and displaying the explanation

### STATEMENT REGARDING FEDERALLY SPONSORED RESEARCH OR DEVELOPMENT

This invention was made with Government support under Government Contract Number W911NF-16-3-0001 awarded by the Army Research Office (ARO). The Government has certain rights to this invention

### BACKGROUND

Aspects of the present invention relate generally to machine learning and, more specifically, to providing explanations for outputs of machine learning models.

Explanations are increasingly being provided with outputs of machine learning models. An explanation associated with the output of a machine learning model, such as a prediction made by the model, is a human-understandable description of why or how the model arrived at that particular prediction. Explanations may be designed to help the end user understand the model prediction by highlighting the most relevant features associated with making the prediction. Faithfulness in this context is a quantitative measure of how closely an explanation identifies the actual features used by a model for a prediction. A faithful explanation is one that accurately represents the reasoning process behind the prediction.

### SUMMARY

In a first aspect of the invention, there is a method including: generating a prediction using a trained machine learning model based on an original input comprising a plurality of input parameters; generating an explanation of which of the plurality of input parameters is most relevant to the prediction based on contextually replacing respective ones of the plurality of input parameters; and displaying the explanation.

In another aspect of the invention, there is a computer program product comprising one or more computer-readable storage media and program instructions stored on the one or more computer-readable storage media to perform operations comprising: generating a prediction using a trained machine learning model based on an original input comprising a plurality of input parameters; generating an explanation of which of the plurality of input parameters is most relevant to the prediction based on contextually replacing respective ones of the plurality of input parameters; and displaying the explanation.

In another aspect of the invention, there is a computer system comprising a processor set, one or more computer-readable storage media, and program instructions stored on the one or more computer-readable storage media to cause the processor set to perform operations comprising: generating a prediction using a trained machine learning model based on an original input comprising a plurality of input parameters; generating an explanation of which of the plurality of input parameters is most relevant to the prediction based on contextually replacing respective ones of the plurality of input parameters; and displaying the explanation.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 depicts an exemplary use case in accordance with aspects of the present invention.

FIG. 4 depicts an exemplary explanation in accordance with aspects of the present invention.

FIG. 5 shows a flowchart of an exemplary method in accordance with aspects of the present invention.

### DETAILED DESCRIPTION

Aspects of the present invention relate generally to machine learning and, more specifically, to providing explanations for outputs of machine learning models. Implementations of the invention are directed to a methodology to provide a faithful explanation for an output (e.g., a prediction) of a machine learning model. Various implementations use a replacement model to perform contextual replacement of input parameters that are included in an input to a machine learning model. Implementations measure the change in a confidence score of the model when the input is modified with respective ones of the contextual replacements and determine an explanation for the model output based on the measured changes in confidence score. In embodiments, the explanation comprises a human-understandable indication of the input parameter that is most relevant to the model output. Implementations provide an explanation with a high degree of faithfulness in part because the contextual replacement of input parameters preserves the semantic and syntactic integrity of the input when evaluating the different input parameters. In this manner, implementations provide an improvement in the technical field of machine learning models generally and in the technical field of providing explanations for outputs of machine learning models specifically.

Current methods to derive faithful explanations for deep learning models are not applicable to many tasks. This is due in part to the fact that for deep learning models there is no ground truth regarding what input parameters are the most relevant to the output of the model. The “occlusion test” is a method that is sometimes used to provide explanations for models. The occlusion test assigns relevance to single variables, or entire words, by occluding them in the input and tracking the difference in the model's prediction with respect to a prediction on the original unmodified input. However, while the occlusion test performs well at providing an explanation for some types of tasks (e.g., predicting a sentiment a sentence), the occlusion test can fail to provide an explanation, or provide an explanation with a low degree of faithfulness, in some other types of tasks (e.g., predicting whether a sentence is grammatically correct). As a result, there is a need for a method of providing a faithful explanation that is generally applicable to a broad range of predictive tasks performed by machine learning models.

Implementations of the present invention address this problem by providing a method for determining a faithful explanation by determining relevance of input parameters based on contextual replacement of the input parameters in the original input and measuring a difference between an output of the model using the original input and an output of the model using the input modified with a contextually replaced input parameter. Using contextual replacement of input parameters preserves the semantic and syntactic integrity of the input when evaluating the different input parameters, and results in an explanation methodology that is highly faithful and that is generally applicable to a broad range of predictive tasks performed by machine learning models. In this manner, implementations provide an improvement in the technical field of machine learning models generally and in providing explanations for outputs of machine learning models specifically.

In accordance with aspects of the invention, there is a method for displaying an explanation for a deep machine learning model prediction, the method comprising: generating a prediction using a deep machine learning model based on an input comprising a plurality of input parameters; generating an explanation of which input parameters had the greatest influence on the prediction; and displaying the explanation. In embodiments, the generating an explanation of which input parameters had the greatest influence on the prediction comprises: for each input parameter, selecting a replacement model to generate alternate values for that input parameter; for each input parameter sequentially generating an alternate prediction based on the deep machine learning model by replacing one input parameter with an alternate value generated by model and evaluating the difference between the original prediction and alternate prediction; and determining the explanation as the input parameter for which the alternate prediction resulted in the greatest difference from the original prediction.

Implementations of the invention are necessarily rooted in computer technology. For example, generating a prediction using a deep machine learning model (also called a deep learning model) is computer-based and cannot be performed in the human mind. Deep learning is a subset of machine learning and involves highly complex models such as recurrent neural networks (RNN), convolutional neural networks (CNN), and generative adversarial networks (GAN), for example. Generating a prediction using a deep learning model is, by definition, performed by a computer and cannot practically be performed in the human mind (or with pen and paper) due to the complexity and massive amounts of calculations involved. For example, an artificial neural network, such as an RNN, CNN, or GAN, may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training a deep learning model and/or generating a prediction using a deep learning model.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as explanation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

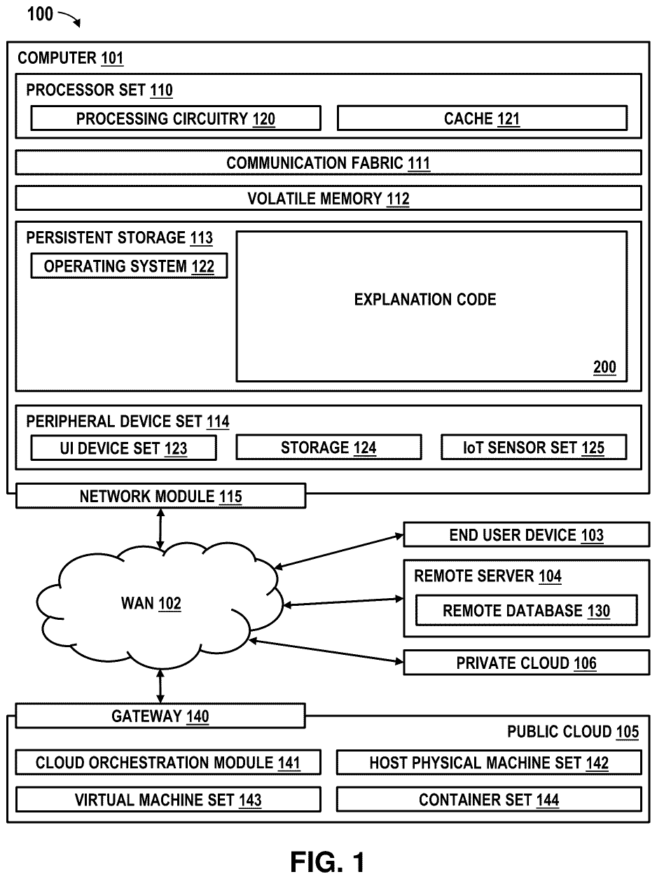

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

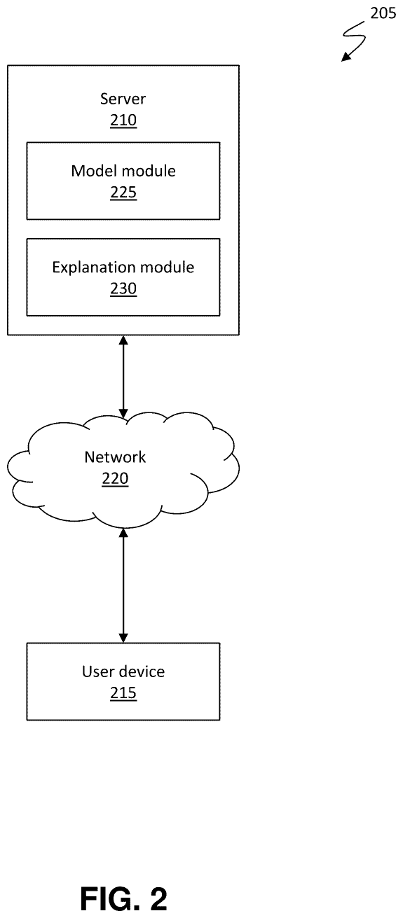

FIG. 2 shows a block diagram of an exemplary environment 205 in accordance with aspects of the invention. In embodiments, the environment 205 includes a server 210 and a user device 215 that communicate via a network 220. In one example, the server 210 comprises a computing device such as one or more instances of the computer 101 of FIG. 1. In another example, the server 210 comprises one or more virtual machines, or one or more containers, running on one or more instances of the computer 101 of FIG. 1. In embodiments, the user device 215 comprises one more instances of the EUD 103 of FIG. 1. In embodiments, the network 220 comprises one or more networks for communicating computer data, such as the WAN 102 of FIG. 1.

In embodiments, the server 210 of FIG. 2 comprises a model module 225 and an explanation module 230, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the model module 225 is configured to receive an input comprising a plurality of input parameters and generate an output using a trained machine learning model with the input. In embodiments, the model module 225 is programmed with the trained machine learning model. In embodiments, the trained machine learning model is a deep learning model that is trained to generate an output based on an input to the model. In embodiments, the deep learning model is a predictive model that generates a prediction based on an input to the model. The deep learning model may comprise a RNN, CNN, or GAN, for example, although other types of deep learning models may be used. The deep learning model may be trained for natural language processing, computer vision, or both. An example of a deep learning model trained for natural language processing is a model that receives an input comprising text and that generates an output based on analyzing the text, such as a sentiment analysis of the text (e.g., the model output is a prediction of positive sentiment or negative sentiment) or a prediction of whether the text is a grammatically correct sentence (e.g., the model output is a prediction, Yes or No, that the text is a grammatically correct sentence). An example of a deep learning model trained for computer vision is a model that receives an input comprising an image and that generates an output based on analyzing the image, such as classifying the image (e.g., the output of the model is a prediction of a classification of the image). These examples are not limiting, and other types of natural language processing and/or computer vision models may be programmed in the model module 225. In embodiments, the trained machine learning model is further configured to generate a confidence score associated with an output generated by the model. Any conventional or later developed technique for generating a confidence score associated with a model output may be programmed in the model module 225.

In accordance with aspects of the invention, the explanation module 230 is configured to generate an explanation associated with an output that is generated by the machine learning model of the model module 225. In embodiments, the explanation comprises an indication of the input parameter that is most relevant to the model output, the indication being in a human-understandable format. For example, the explanation may comprise text and/or images displayed on a computing device such as the user device 215. In accordance with aspects of the invention, the explanation module 230 is configured to generate the explanation by: contextually replacing respective ones of a plurality of input parameters that are included in an original input to the machine learning model of model module 225; measuring a change in the confidence score generated by the machine learning model when the original input is modified with respective ones of the contextual replacements; and determining a respective one of the input parameters that results in a greatest different in confidence score generated by the machine learning model.

In embodiments, the contextually replacing respective ones of a plurality of input parameters comprises: for a respective one of the input parameters in the original input, using a replacement model to determine plural contextual replacements for the respective one of the input parameters; and modifying the original input by replacing the respective one of the input parameters with one of the determined contextual replacements. In embodiments in which the machine learning model of model module 225 is a natural language processing model, the replacement model may comprise a trained masked language modeling model that is trained to predict masked tokens within an input sequence. In embodiments in which the machine learning model of model module 225 is a computer vision model, the replacement model may comprise a trained masked object classification model or a masked region feature model. By using these types of models, the explanation module 230 is configured to generate a modified version of the original input to the machine learning model, the modified version having a respective one of the input parameters replaced with a value that is different than, but contextually similar to, the original value of the respective one of the input parameters (i.e., the original being the value of this input parameter in the original input). In embodiments, the explanation module 230 determines a predefined number of contextual replacements for each respective one of the input parameters in the original input. The predefined number may be a configurable parameter that a user may adjust via the user device 215.

In embodiments, the measuring a change in the confidence score generated by the machine learning model when the original input is modified with respective ones of the contextual replacements comprises: generating a first confidence score associated with a first output that is generated by the machine learning model using the original input; generating a second confidence score associated with a second output that is generated by the machine learning model using the original input modified with a contextual replacement; and determining a difference between the first confidence score and the second confidence score. In embodiments, the explanation module 230 determines a respective change in confidence score for each respective one of the contextual replacements for each respective one of the input parameters in the original input. In this manner, for each respective one of the input parameters in the original input, the explanation module 230 generates the predefined number of contextual replacements and a respective change in confidence score associated with each respective one of the contextual replacements.

In embodiments, the determining a respective one of the input parameters that results in the greatest different in confidence score comprises: comparing the respective change in confidence score for each respective one of the contextual replacements for each respective one of the input parameters in the original input; and determining, based on the comparing, which of the input parameters has the contextual replacement that has a highest change in confidence score amongst all the contextual replacements for all the input parameters. The one of the input parameters that has the contextual replacement that has the highest change in confidence score amongst all the contextual replacements for all the input parameters is thus determined as the one of the input parameters that is most relevant to the output of the machine learning model associated for this particular input (i.e., the original input). In embodiments, the explanation comprises an identification of this determined one of the input parameters.

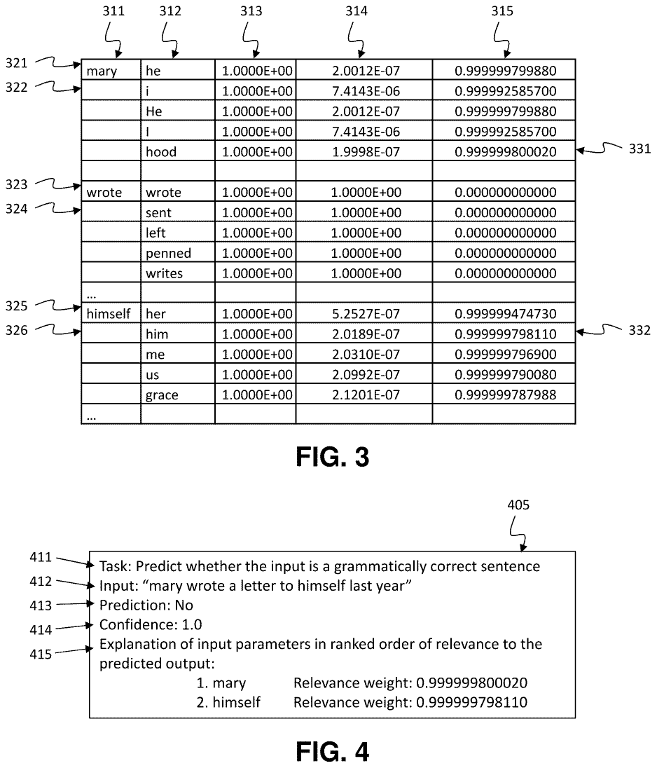

FIG. 3 shows an example that illustrates aspects of the present invention. Operations carried out in the example may be performed in the environment of FIG. 2 and are described with reference to elements depicted in FIG. 2. In this example, the model module 225 is programmed with a deep learning model that is trained to predict whether a text input comprises a grammatically correct sentence. In this example, the input to the model comprises a plurality of words, and the output of the model comprises a prediction (e.g., Yes or No) of whether the input is a grammatically correct sentence, and a confidence score associated with the prediction. The input may be manually entered by a user via the user device 215, e.g., by typing, highlighting text in a document, indicating a file containing the text, etc. In this example, the confidence score is a number between 0 and 1 with numbers closer to 0 representing lower confidence and numbers closer to 1 representing higher confidence. In this example, the original input to the model is “mary wrote a letter to himself last year” and the output of the model based on this input is a prediction of No with a confidence score of 1.0.

In the table shown in FIG. 3, column 311 represents the respective input parameters of the original input. In this example, the original input comprises “mary wrote a letter to himself last year” and the plurality of input parameters comprise “mary”, “wrote”, “a”, “letter”, “to”, “himself”, “last”, and “year”. For brevity, only three of the respective input parameters are shown in FIG. 3, but it is understood that each of the input parameters may be analyzed in the manner shown in FIG. 3.

Column 312 represents the contextual replacements generated by the explanation module 230 for each respective input parameter. In this example, the explanation module 230 uses a replacement model, such as a trained masked language modeling model, to generate the contextual replacements. For example, for determining the contextual replacements associated with the input parameter “mary”, the explanation module 230 generates an input string for the replacement model in the form of “[mask] wrote a letter to himself last year” and, based on this input string, the replacement model generates the contextual replacements “he”, “i”, “He”, “I”, and “hood” for the masked word in the input string. Similarly, for determining the contextual replacements associated with the input parameter “wrote”, the explanation module 230 generates an input string for the replacement model in the form of “mary [mask] a letter to himself last year” and, based on this input string, the replacement model generates the contextual replacements “wrote”, “sent”, “left”, “penned”, and “writes” for the masked word in the input string.

Column 313 represents the confidence score associated with the prediction generated by the deep learning model (of the model module 225) based on the original input. In this example, that confidence score is 1.0.

Column 314 represents the confidence score associated with the prediction generated by the deep learning model (of the model module 225) based on a modified input that comprises the original input modified by replacing one of the input parameters with one of the contextual replacements. For example, in row 321, the modified input to the deep learning model is “he wrote a letter to himself last year” with the contextual replacement “he” being used in place of the input parameter “mary”, and the value of 2.0012E-07 is the confidence score associated with the prediction generated by the deep learning model based this modified input.

In row 322, the modified input to the deep learning model is “i wrote a letter to himself last year” with the contextual replacement “i” being used in place of the input parameter “mary”, and the value of 7.4143E-06 is the confidence score associated with the prediction generated by the deep learning model based this modified input.

In row 323, the modified input to the deep learning model is “mary wrote a letter to himself last year” with the contextual replacement “wrote” being used in place of the input parameter “wrote”, and the value of 1.0000E+00 is the confidence score associated with the prediction generated by the deep learning model based this modified input.

In row 324, the modified input to the deep learning model is “mary sent a letter to himself last year” with the contextual replacement “sent” being used in place of the input parameter “wrote”, and the value of 1.0000E+00 is the confidence score associated with the prediction generated by the deep learning model based this modified input.

In row 325, the modified input to the deep learning model is “mary wrote a letter to her last year” with the contextual replacement “her” being used in place of the input parameter “himself”, and the value of 5.2527E-07 is the confidence score associated with the prediction generated by the deep learning model based this modified input.

In row 326, the modified input to the deep learning model is “mary wrote a letter to him last year” with the contextual replacement “him” being used in place of the input parameter “himself”, and the value of 2.0189E-07 is the confidence score associated with the prediction generated by the deep learning model based this modified input.

Still referring to FIG. 3, the other rows, although not labeled with reference numbers, are treated in a similar manner as described with respect to rows 321-326. In this manner, the explanation module 230 generates a respective confidence score for a respective modified input associated with each respective one of the contextual replacements for each respective one of the input parameters in the original input.

With continued reference to FIG. 3, column 315 represents the respective change in confidence score for each respective one of the contextual replacements for each respective one of the input parameters in the original input. In this example, for each particular row, the value in column 315 is the difference between the value in column 313 and the value in column 314.

In the example shown in FIG. 3, cell 331 has the highest value in column 315. Based on this, the explanation module 230 determines that the input parameter associated with the row containing this cell, i.e., “mary” in this example, is the one of the input parameters that is most relevant to the output of the machine learning model associated for this particular input (i.e., the original input).

In embodiments, the explanation module 230 may be configured to rank a predefined number of the input parameters or even all the input parameters in the original input. In the example of FIG. 3, after determining that the input parameter “mary” is the first ranked input parameter, the explanation module 230 then analyzes the values represented by column 315 to determine which of the remaining input parameters (i.e., other than “mary”) has the contextual replacement with the highest respective change in confidence score. In the example of FIG. 3, the second ranked input parameter is “himself” based on the value at cell 332. In this manner, the explanation module 230 may be configured to rank a single one of the input parameters, a subset of less than all the input parameters, or all the input parameters, in terms of ranked relevance to the output generated by the machine learning model associated for the original input.

FIG. 3 has been described thus far as determining the next highest ranked input parameter based on determining a single highest change in confidence score for each respective one of the contextual replacements for the remaining ones of the input parameters. However, instead of considering the change in confidence score associated with each respective one of the contextual replacements, other implementations may use different mathematical functions. Examples include but are not limited to: a sum of the changes in confidence score for respective ones of the contextual replacements for a respective one of the input parameters; a median of the changes in confidence score for respective ones of the contextual replacements for a respective one of the input parameters; and a median of the changes in confidence score for respective ones of the contextual replacements for a respective one of the input parameters.

FIG. 4 shows an example result 405 based on the example use case of FIG. 3 and in accordance with aspects of the present invention. The result 405 may be displayed to a user via an interface of the user device 215 of FIG. 2. In this example, the result 405 includes: a description 411 of what task the machine learning model performs; an indication of the original input 412 to the model; an indication of the output 413 generated by the model based on the input 412; an indication of the confidence score 414 associated with the output 413; and an explanation 415 of the two highest ranked terms of the input 412 ranked in order of relevance to the output 413 generated by the model. The result 405 is exemplary and other formats of output may be used with implementations.

For example, in another implementation, the deep learning model of model module 225 might be trained to receive an image of a manufactured part as an input and to generate a prediction of whether the part shown in the image has a defect. In this example, the explanation module 230 may be configured to determine an area of the image that is most relevant to the prediction generated by the model for this image and to generate a result that shows the image, the prediction, and an explanation comprising a highlighted area of the image that corresponds to the area of the image that is determined to be most relevant to the prediction. In this example, the input to the model (i.e., the image) may be obtained by a camera positioned in or near the manufacturing floor and that captures the image of the part automatically and provides the image to the server 210 automatically. In this example, upon receipt of the image from the camera, the server 210 may use the model module 225 to generate the prediction and may use the explanation module 230 to generate the explanation, and the server 210 may cause the user device 215 to display a result that includes the prediction, the confidence score, and the explanation. In this manner, the entire process may be automated and presented to a user via the user device 215.

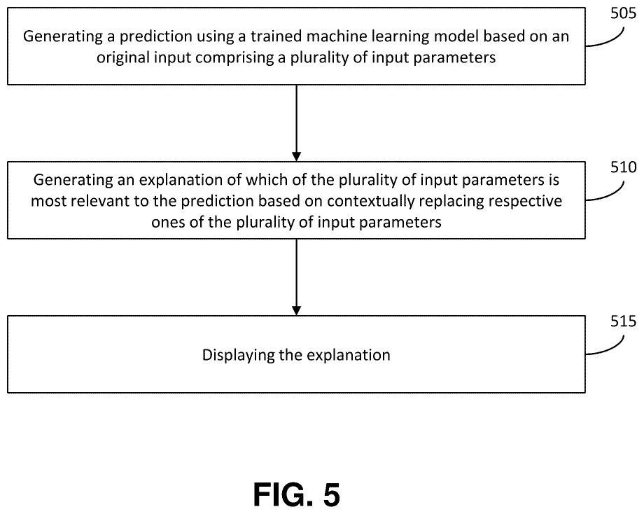

FIG. 5 shows a flowchart of an exemplary method in accordance with aspects of the present invention. Steps of the method (also referred to as operations) may be carried out in the environment of FIG. 2 and are described with reference to elements depicted in FIG. 2.

At step 505 the system generates a prediction using a trained machine learning model based on an original input comprising a plurality of input parameters. In embodiments, the model module 225 generates the prediction using a trained machine learning model.

At step 510 the system generates an explanation of which of the plurality of input parameters is most relevant to the prediction based on contextually replacing respective ones of the plurality of input parameters. In embodiments, the explanation module 230 generates the explanation in a manner similar to that described with respect to FIGS. 2-4.

At step 515, the system displays the explanation. In some embodiments, the server 210 displays a result (e.g., such as result 405) that includes the explanation. In some embodiments, the server 210 causes the user device 215 to display a result (e.g., such as result 405) that includes the explanation.

In embodiments of the method, the contextually replacing respective ones of the plurality of input parameters comprises generating contextual replacements associated with each respective one of the plurality of input parameters.

In embodiments of the method, the contextually replacing respective ones of the plurality of input parameters further comprises generating modified inputs associated with each of the respective contextual replacements associated with each respective one of the plurality of input parameters.

In embodiments of the method, a respective one of the modified inputs associated with a respective one of the contextual replacements associated with a respective one of the plurality of input parameters comprises the original input modified by replacing the respective one of the plurality of input parameters with the respective one of the contextual replacements.

In embodiments of the method, the generating the explanation comprises: generating respective predictions and respective confidence scores using the trained machine learning model based on respective ones of the modified inputs; and determining, based on the respective confidence scores, that a particular one of the plurality of input parameters is most relevant to the prediction that is based on the original input.

In embodiments of the method, the generating the explanation comprises: generating respective predictions and respective confidence scores using the trained machine learning model based on respective ones of the modified inputs; and determining, based on the respective confidence scores, a ranking of plural ones of the plurality of input parameters in order of relevance to the prediction that is based on the original input.

In embodiments of the method, the generating the contextual replacements is performed using a trained replacement model that is different than the trained machine learning model.

In embodiments of the method, the trained machine learning model comprises a deep learning model.

In embodiments of the method, the input comprises a text string, the plurality of input parameters comprises plural words or phrases in the text string, and the explanation comprises an indication one or more of the words or phrases that are determined as most relevant to the prediction.

In embodiments of the method, the input comprises an image, the plurality of input parameters comprises areas of the image, and the explanation comprises an indication one or more of the areas that are determined as most relevant to the prediction.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating a prediction using a trained machine learning model based on an original input comprising a plurality of input parameters;
generating an explanation of which of the plurality of input parameters is most relevant to the prediction based on contextually replacing respective ones of the plurality of input parameters; and
displaying the explanation.

2. The method of claim 1, wherein the contextually replacing respective ones of the plurality of input parameters comprises generating contextual replacements associated with each respective one of the plurality of input parameters.

3. The method of claim 2, wherein the contextually replacing respective ones of the plurality of input parameters further comprises generating modified inputs associated with each of the respective contextual replacements associated with each respective one of the plurality of input parameters.

4. The method of claim 3, wherein a respective one of the modified inputs associated with a respective one of the contextual replacements associated with a respective one of the plurality of input parameters comprises the original input modified by replacing the respective one of the plurality of input parameters with the respective one of the contextual replacements.

5. The method of claim 4, wherein the generating the explanation comprises:
generating respective predictions and respective confidence scores using the trained machine learning model based on respective ones of the modified inputs; and
determining, based on the respective confidence scores, that a particular one of the plurality of input parameters is most relevant to the prediction that is based on the original input.

6. The method of claim 4, wherein the generating the explanation comprises:
generating respective predictions and respective confidence scores using the trained machine learning model based on respective ones of the modified inputs; and
determining, based on the respective confidence scores, a ranking of plural ones of the plurality of input parameters in order of relevance to the prediction that is based on the original input.

7. The method of claim 2, wherein the generating the contextual replacements is performed using a trained replacement model that is different than the trained machine learning model.

8. The method of claim 1, wherein the trained machine learning model comprises a deep learning model.

9. The method of claim 1, wherein:
the input comprises a text string;
the plurality of input parameters comprises plural words or phrases in the text string; and
the explanation comprises an indication one or more of the words or phrases that are determined as most relevant to the prediction.

10. The method of claim 1, wherein:
the input comprises an image;
the plurality of input parameters comprises areas of the image; and
the explanation comprises an indication one or more of the areas that are determined as most relevant to the prediction.

11. A computer program product comprising:
one or more computer-readable storage media; and
program instructions stored on the one or more computer-readable storage media to perform operations comprising:
generating a prediction using a trained machine learning model based on an original input comprising a plurality of input parameters;
generating an explanation of which of the plurality of input parameters is most relevant to the prediction based on contextually replacing respective ones of the plurality of input parameters; and
displaying the explanation.

12. The computer program product of claim 11, wherein:
the contextually replacing respective ones of the plurality of input parameters comprises generating contextual replacements associated with each respective one of the plurality of input parameters;
the contextually replacing respective ones of the plurality of input parameters further comprises generating modified inputs associated with each of the respective contextual replacements associated with each respective one of the plurality of input parameters; and
a respective one of the modified inputs associated with a respective one of the contextual replacements associated with a respective one of the plurality of input parameters comprises the original input modified by replacing the respective one of the plurality of input parameters with the respective one of the contextual replacements.

13. The computer program product of claim 12, wherein the generating the explanation comprises:
generating respective predictions and respective confidence scores using the trained machine learning model based on respective ones of the modified inputs; and
determining, based on the respective confidence scores, that a particular one of the plurality of input parameters is most relevant to the prediction that is based on the original input.

14. The computer program product of claim 12, wherein the generating the explanation comprises:
generating respective predictions and respective confidence scores using the trained machine learning model based on respective ones of the modified inputs; and
determining, based on the respective confidence scores, a ranking of plural ones of the plurality of input parameters in order of relevance to the prediction that is based on the original input.

15. The computer program product of claim 11, wherein the trained machine learning model comprises a deep learning model configured to perform natural language processing or computer vision.

16. A computer system comprising:
a processor set;
one or more computer-readable storage media; and
program instructions stored on the one or more computer-readable storage media to cause the processor set to perform operations comprising:
one or more computer-readable storage media; and
program instructions stored on the one or more computer-readable storage media to perform operations comprising:
generating a prediction using a trained machine learning model based on an original input comprising a plurality of input parameters;
generating an explanation of which of the plurality of input parameters is most relevant to the prediction based on contextually replacing respective ones of the plurality of input parameters; and
displaying the explanation.

17. The computer system of claim 16, wherein:
the contextually replacing respective ones of the plurality of input parameters comprises generating contextual replacements associated with each respective one of the plurality of input parameters;
the contextually replacing respective ones of the plurality of input parameters further comprises generating modified inputs associated with each of the respective contextual replacements associated with each respective one of the plurality of input parameters; and
a respective one of the modified inputs associated with a respective one of the contextual replacements associated with a respective one of the plurality of input parameters comprises the original input modified by replacing the respective one of the plurality of input parameters with the respective one of the contextual replacements.

18. The computer system of claim 17, wherein the generating the explanation comprises:
generating respective predictions and respective confidence scores using the trained machine learning model based on respective ones of the modified inputs; and
determining, based on the respective confidence scores, that a particular one of the plurality of input parameters is most relevant to the prediction that is based on the original input.

19. The computer system of claim 17, wherein the generating the explanation comprises:
generating respective predictions and respective confidence scores using the trained machine learning model based on respective ones of the modified inputs; and
determining, based on the respective confidence scores, a ranking of plural ones of the plurality of input parameters in order of relevance to the prediction that is based on the original input.

20. The computer system of claim 16, wherein the trained machine learning model comprises a deep learning model configured to perform natural language processing or computer vision.
